(19) United States
(12) Patent Application Publication
(10) Pub. No.: US 2024/0061735 A1
(43) Pub. Date: Feb. 22, 2024

(54) SYSTEMS AND METHODS FOR INFRASTRUCTURE RESILIENCE ESTIMATION AND ASSESSMENT

(71) Applicant: University of Connecticut, Farmington, CT (US)

(72) Inventors: Peter Watson, Farmington, CT (US); Emmanouil Anagnostou, Farmington, CT (US); Diego Cerrai, Farmington, CT (US); Wei Zhang, Farmington, CT (US); William Hughes, Farmington, CT (US); William Taylor, Farmington, CT (US); Amvrossios Bagtzoglou, Farmington, CT (US)

(21) Appl. No.: 18/450,305

(22) Filed: Aug. 15, 2023

Related U.S. Application Data
(60) Provisional application No. 63/397,985, filed on Aug. 15, 2022.

(51) Int. Cl. G06F 11/00

(52) U.S. Cl. CPC G06F 11/004; G06F 2201/81

(57) ABSTRACT

Systems and methods for assessing the resilience of an infrastructural system. The system includes a computer program product stored on non-transitory machine-readable media. The media includes machine executable instructions for implementing a method for assessing the resilience of an infrastructural system. The method includes receiving, from an interface, scenario specific data regarding conditions for the infrastructural system; processing the scenario specific data to determine a vulnerability metric for a probability of failure for a component of the infrastructural system; determining, based on the vulnerability metric, an in-situ failure risk of the infrastructural system incorporating a complexity of environmental conditions; determining, based on the vulnerability metric, a recommended maintenance task for the component of the infrastructural system; and providing the in-situ failure risk of the infrastructural system and the recommended maintenance task for the component to the interface.

### CROSS-REFERENCE TO RELATED APPLICATIONS

This application claims priority to U.S. Provisional Patent Application No. 63/397,985, filed Aug. 15, 2022, which is incorporated herein by reference in its entirety.

### TECHNICAL FIELD

This disclosure relates to systems and methods for management of infrastructure, and in particular to systems and methods for mitigating risk of failure of infrastructure.

### BACKGROUND

Modern society relies heavily upon expansive and organized systems designed to serve a broad range of public and private needs. Critical infrastructure includes highway systems, telecommunications networks, electric transmission and distribution systems and many similar constructs. History teaches that failure of components within any given infrastructure can be annoying, disruptive, and in some instances, extremely costly.

Generally, infrastructural systems include multi-component engineered systems that are distributed spatially and are often employed to deliver services and functions for multiple customers or users. Some further examples of infrastructural systems include oil pipelines, electrical transmission lines, road networks, and the like. Predicting needed maintenance is difficult because of the complexity of such systems. Often components have different designs, specifications, materials, and aging that can affect the risk of failure. Moreover, differences in the surrounding environment and exposure to hazards of various parts of infrastructure can affect the likelihood of failure. The aspects of component design and environmental risk factors that contribute to the overall reliability of infrastructure as well as possible changes to improve resilience to hazards must also be considered.

Thus, what are needed are systems, methods, and apparatuses to aid in maintenance management of an infrastructural system. The solutions should be sensitive to ongoing operational and equipment conditions.

### SUMMARY

Embodiments disclosed are generally directed to computer program products and systems for assessing resilience of infrastructural components to enable efficient maintenance evolutions. The system determines, for example, a risk of failure by modeling exposure, of the infrastructural components, to hazardous environmental conditions, which is informed by various aspects of the infrastructural components. In some embodiments, these systems determine the risk of damage to the infrastructure from the hazardous environmental conditions. In some embodiments, the systems employ data describing various aspects of the infrastructural components, natural hazards, and environmental conditions to model the risk of damage to the infrastructure from the hazard. In some embodiments, the model is a machine-learning model that is trained on the collected historical data of damaging or disruptive events from prior hazards and the infrastructural system such that the model can be employed to determine the amount of damage for infrastructure of various designs and characteristics. Moreover, because this infrastructure reliability model is sensitive to different aspects of the infrastructure, environment, and natural hazards, upgrades to the infrastructural system can be evaluated and reductions in risk of failure in adverse conditions can be quantified. Results are provided to users, such as system operators and enable timely and effective maintenance.

Examples of maintenance evolutions that may be indicated by the results include component replacement or refurbishment, infrastructure design changes, including component removal or additions, and other tasks of a similar nature.

In some embodiments, the infrastructure resilience assessment system is employed to predict events as well as long-term trends within an infrastructural system. For example, infrastructure managers and strategic planners may employ the described system to quantify the reliability of systems under various scenarios for planning purposes. In some embodiments, the system processes infrastructural components independently and does not require a functional model of the networked infrastructure. In some embodiments, the system summarizes physical characteristics of the infrastructure structural models or laboratory tests. In some embodiments, the reliability of the system is determined, under various configurations, by treating characteristics of the infrastructure as a variable. In some embodiments, the system enables informed decision making and helps improve the reliability of infrastructural systems by providing cost-benefit analysis for various infrastructural improvements. In some embodiments, the described system estimates the performance of a system under climate change as well as the effects of different infrastructural upgrades and improvements on the system. The estimation(s) and other data are output to the user, and in some embodiments, can include one or more recommendations for maintenance or upgrades to prevent future failure of the infrastructural systems.

Accordingly, in one aspect, disclosed herein are computer program products that are stored on non-transitory machine-readable media. The non-transitory machine-readable media includes machine executable instructions for implementing a method for assessing the resilience of an infrastructural system. The method includes receiving, from an interface, scenario specific data regarding conditions for the infrastructural system, processing the scenario specific data to determine a vulnerability metric for a probability of failure for a component of the infrastructural system, determining, based on the vulnerability metric, an in-situ failure risk of the infrastructural system incorporating a complexity of environmental conditions, determining, based on the vulnerability metric, a recommend maintenance task for the component of the infrastructural system, and providing the in-situ failure risk of the infrastructural system and the recommend maintenance task for the component to the interface.

### BRIEF DESCRIPTION OF THE DRAWINGS

FIG. 1 depicts an example system that includes a computer or computing device that can be programmed or otherwise configured to implement the systems and methods described herein.

FIG. 2 depicts an example environment that can be employed to execute the systems and methods described herein.

FIG. 3 depicts an example architecture for the infrastructure resilience assessment system.

FIG. 4 depicts an example of various inputs that are aggregated and provided to a data module.

FIG. 5A depicts an example analytical system output of a single event reliability prediction.

FIG. 5B depicts an example analytical system output of an aggregate reliability map.

FIG. 5C depicts an example analytical system output of a reliability risk reduction plot.

FIG. 5D depicts an example analytical system output of a return period table.

FIG. 6 depicts a non-limiting example of a page of a user interface that can be employed to provide information to a user.

FIG. 7 depicts a flowchart of a non-limiting process for assessing the resilience of an infrastructural system.

### DETAILED DESCRIPTION

Systems, methods, apparatus and computer program products are provided for monitoring and assessing the ability of an infrastructure system to withstand failure. Generally, the techniques disclosed herein are useful for modeling, and therefore mitigating, risk of failure of the infrastructure system and components of the infrastructure system. The techniques presented make use of, among other things, inputs, models, and other forms of predictive information in order to develop meaningful output for users. The output is useful for managing and monitoring maintenance, upgrades, and engineering modifications to the infrastructure. As a result, involved parties, such as infrastructure system owners, operators and maintainers are provided with enhanced capabilities to ensure continued operability and can efficiently limit expenses and resource investment.

In general, an infrastructural system includes many components. For example, an infrastructural system could include more than one hundred, one thousand, ten thousand, or one hundred thousand components. Examples of infrastructural systems include, but are not limited to, oil pipelines; electrical transmission lines; road networks; transportation systems, such as those provided at a municipal, state, and federal level; utility systems, such as electric, gas, communications, water and sewer; and the like. Classes of components may be considered as an infrastructural system. For example, all bridges within a service or geographic area may be an infrastructural system to which an implementation of the teachings herein is adapted. For example, the system described herein may be employed to model resilience or risk of failure of a component of a city or components within a large parcel of land. As another example, the infrastructural system may encompass all components of a utility company that provides services to millions of customers. In this context, the infrastructural system would include, for example, power plants, transformers, relays, administrative facilities, power lines and poles, and the like. In such a utility example, the infrastructural system would include an extremely large number (e.g., greater than hundreds, thousands or millions) of components desirable of being maintained and monitored. Thus, the system described herein can evaluate the various components to provide information to a user related to resiliency, ability to withstand a hazard or natural disaster type event, and risk of failure. The system described herein also can provide information related to maintenance needs of one or more components and can indicate a desired timeframe in which to conduct the maintenance to prevent failure of a component in the infrastructural system.

Before disclosing the subject matter in greater detail, some context including terminology used herein is introduced.

### Definitions

As used herein, the term “infrastructural system” generally includes a multi-component engineered system that may be distributed spatially (e.g., spread out over a large area), often delivering services and functions for multiple customers or users.

As used herein, the term “scenario specific data” generally includes information about a combination of environmental, operational, infrastructural, and/or meteorological conditions specific to a particular place and time either real or theoretical.

As used herein, the terms “in-situ failure (risk),” “risk of failure” and other similar terms generally refer to the risk of failure or diminished operational capacity of a system that is deployed and operating in real-world conditions.

As used herein, the term “vulnerability metric” generally includes a numerical value that describes the risk of failure in a component of the infrastructural system under certain conditions.

As used herein, the term “historical data” generally includes infrastructure data, spatial data, fragility features data, hazard features data, or historical risk feature data, regarding the infrastructural system.

As used herein, the term “spatial data” generally includes information linked to a specific location, or collection of locations, such as a point, line, or area in space. Spatial data may also include regular patterns of information (e.g., a grid) that are associated with a specific area.

As used herein, the term “fragility features data” generally includes values that describe risk of failure in the system, potentially as a result of certain environmental conditions.

As used herein, the term “hazard features data” generally includes information that describes characteristics of a hazard to the system. Examples include maximum wind speed during a hurricane, air temperature in a heatwave, and convective energy during a thunderstorm.

As used herein, the term “historical risk feature data” generally includes information that describes previous failures or disruptions in the system, or values that describe historical system resilience.

As used herein, the term “resilience” generally includes the ability of a system to resist or recover from disruptions.

As used herein, “fragility curves” relates to a function that generally defines a probability of exceeding a given damage state as a function of environmental change (note that the aspect of “curves” generally relates to embodiments where a graphic depiction of the function is realized or possible). Fragility curves can be used to define the probability of component failure due to, for example, component age. As one example, to estimate earthquake damage, fragility curves are defined as a function of peak ground acceleration, peak ground velocity, or repair rate. As another example, fragility curves can also be defined as a function of flood stage, wind speed, and temperature for other types of disasters. Another example includes assessment of component age and wear and resulting reduction in component strength. Other similar terminology may be used.

In some embodiments, the infrastructure resilience assessment system is employed to determine a risk of failure for a modeled collection of components of a particular infrastructure (also referred to as an “infrastructural system”) and generate results for any subset of the modeled infrastructure. A modeled infrastructure can include, for example, a technical function (e.g., a power circuit), a geographical location (e.g., along a coastline), or political borders (e.g., a town, state, country). In some embodiments, the infrastructure resilience assessment system determines a range of analytical results that include, for example, an aggregate risk of failure for a particular hazardous event, an overall reliability of the system over periods of time, or scenario-based analysis to evaluate the effects of upgrades to the infrastructural system or other hypothetical scenarios.

In some embodiments, the infrastructure resilience assessment system includes predictive information describing the physical response of components and materials which generally wear and degrade over time and may be exposed to environmental conditions, and external influence such as weather, spills, fires and various other hazards.

In some embodiments, the predictive information includes component fragility for different component designs and configurations. In some embodiments, the predictive information is developed from manufacturer technical specifications, laboratory tests, or computerized physical simulations. In some embodiments, the predictive information is processed through a trained infrastructural system model to derive the probability of component failure under, for example, idealized conditions. In some embodiments, the determined probability of component failure is translated into in-situ failure risk, which incorporates the complexity of specific environmental conditions.

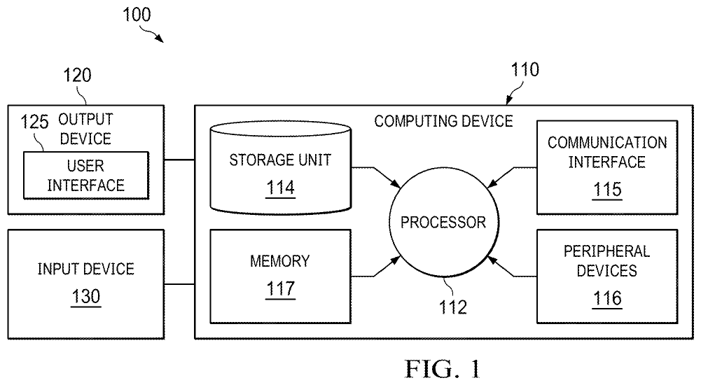

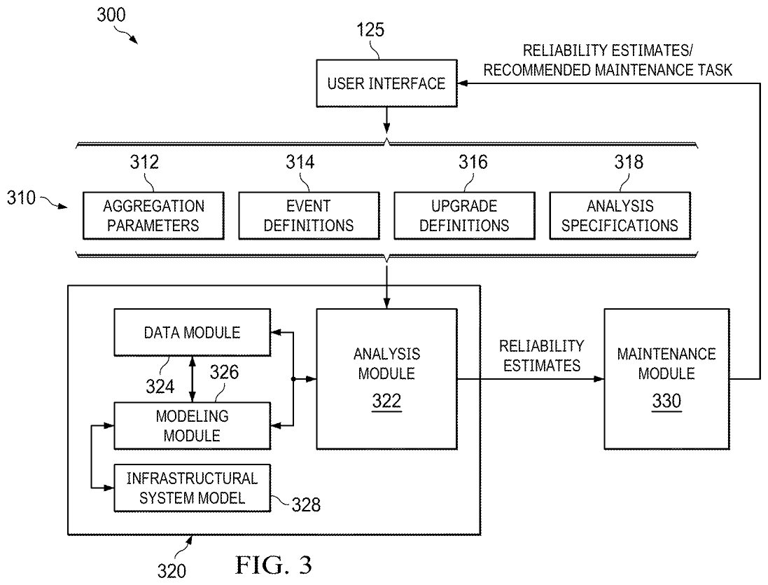

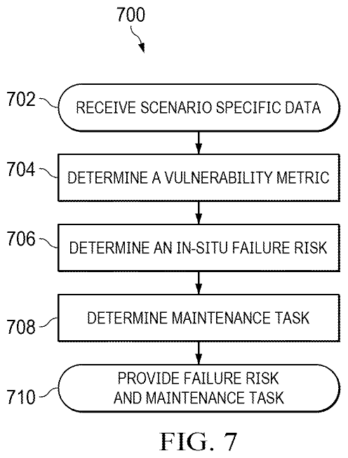

FIG. 1 depicts an example of a system 100 that includes a computer or computing device 110 that can be programmed or otherwise configured to implement systems or methods of the present disclosure. For example, the computing device 110 can be programmed or otherwise configured to implement an infrastructure resilience assessment module 320 described below with reference to FIG. 3 and the process 700 described below with reference to FIG. 7.

The computer or computing device 110 includes an electronic processor (also “central processing unit” (CPU), “processor,” and “computer processor” herein) 112, which is optionally a single core, a multi core processor, or a plurality of processors for parallel processing. The depicted embodiment also includes memory 117 (e.g., random-access memory, read-only memory, flash memory), electronic storage unit 114 (e.g., hard disk or flash), communication interface 115 (e.g., a network adapter or modem) for communicating with one or more other systems, and peripheral devices 116, such as cache, other memory, data storage, microphones, speakers, and the like. In some embodiments, the memory 117, storage unit 114, communication interface 115 and peripheral devices 116 are in communication with the electronic processor 112 through a communication bus (shown as solid lines), such as a motherboard. In some embodiments, the bus of the computing device 110 includes multiple buses. In some embodiments, the computing device 110 includes more or fewer components than those illustrated in FIG. 1 and performs functions other than those described herein.

In some embodiments, the memory 117 and storage unit 114 include one or more physical apparatuses used to store data or programs on a temporary or permanent basis. In some embodiments, the memory 117 is volatile memory and requires power to maintain stored information. In some embodiments, the storage unit 114 is non-volatile memory and retains stored information when the computer is not powered. In further embodiments, memory 117 or storage unit 114 is a combination of devices such as those disclosed herein. In some embodiments, memory 117 or storage unit 114 is distributed across multiple machines such as a network-based memory or memory in multiple machines performing the operations of the computing device 110.

In some cases, the storage unit 114 is a data storage unit or data store for storing data. In some instances, the storage unit 114 stores files, such as drivers, libraries, and saved programs. In some embodiments, the storage unit 114 stores user data (e.g., user preferences and user programs). In some embodiments, the computing device 110 includes one or more additional data storage units that are external, such as being located on a remote server that is in communication through an intranet or the internet.

In some embodiments, methods as described herein (e.g., process 700 described in FIG. 7) are implemented by way of machine or computer executable code stored on an electronic storage location of the computing device 110, such as, for example, on the memory 117 or the storage unit 114. In some embodiments, the electronic processor 112 is configured to execute the code. In some embodiments, the machine executable or machine-readable code is provided in the form of software. In some cases, the code is retrieved from the storage unit 114 and stored on the memory 117 for ready access by the electronic processor 112.

The electronic processor 112 is configured to perform various operations, such as fetching, decoding, executing, and writing back, and the like. In some cases, the electronic processor 112 is a component of a circuit, such as an integrated circuit. One or more other components of the computing device 110 can be optionally included in the circuit. In some cases, the circuit is an application specific integrated circuit (ASIC) or a field programmable gate arrays (FPGAs). In some cases, the operations of the electronic processor 112 can be distributed across multiple machines (where individual machines can have one or more processors) that can be coupled directly or across a network.

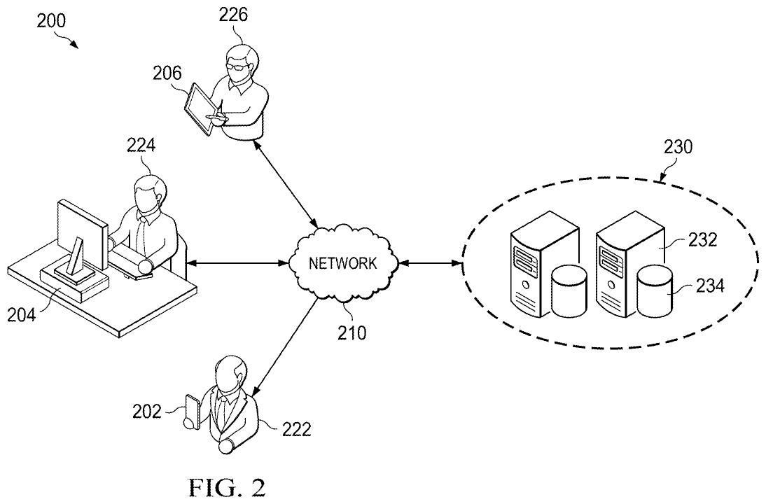

With reference to FIG. 2, in some embodiments, the computing device 110 is optionally operatively coupled to a communication network, such as a network 210 via the communication interface 115. In some embodiments, the computing device 110 communicates with one or more remote computer systems through the network 210. In some embodiments, a user can access the computing device 110 via the network 210. In some embodiments, the computing device 110 is configured as a node within a peer-to-peer network.

With continued reference to FIG. 1, in some embodiments, the computing device 110 includes or is in communication with one or more output devices 120. In some embodiments, the output device 120 includes a display to send visual information to a user. In some embodiments, the output device 120 is a touch sensitive display that combines a display with a touch sensitive element that is operable to sense touch inputs as and functions as both the output device 120 and the input device 130. In still further embodiments, the output device 120 is a combination of devices such as those disclosed herein. In some embodiments, the output device 120 displays a user interface 125 generated by the computing device (e.g., software executed by the computing device 110).

In some embodiments, the computing device 110 includes or is in communication with one or more input devices 130 that are configured to receive information from a user. In some embodiments, the input device 130 is a keyboard. In some embodiments, the input device 130 is a keypad (e.g., a telephone-based keypad). In some embodiments, the input device 130 is a cursor-control device including, by way of non-limiting examples, a mouse, trackball, trackpad, joystick, game controller, or stylus. In some embodiments, as described above, the input device 130 is a touchscreen or a multi-touchscreen. In other embodiments, the input device 130 is a microphone to capture voice or other sound input. In other embodiments, the input device 130 is a camera or video camera. In still further embodiments, the input device is a combination of devices such as those disclosed herein.

In some embodiments, the computing device 110 includes an operating system configured to perform executable instructions. The operating system is, for example, software, including programs and data that manages the hardware of the device and provides services for execution of applications.

With reference to FIG. 2, the computing device 110 may be embodied in an electronic device 202, 204, and 206, which can include, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. The electronic devices 202, 204, 206 can communicate to a back-end system 230 via a communication network 210.

Three electronic devices 202, 204, and 206 are depicted in FIG. 2 for simplicity. As illustrated, the electronic device 202 is depicted as a smartphone, the electronic device 204 is depicted as a tablet-computing device, and the electronic device 206 is depicted as a desktop computing device. It is contemplated, however, that embodiments of the present disclosure can be realized with any suitable computing devices, such as those mentioned previously and the like. Moreover, embodiments of the present disclosure can employ any number of devices.

In some examples, users 222, 224, and 226 of the electronic devices 202, 204, and 206 interact with the system through a graphical user interface (GUI) (e.g., the user interface 125) or an application that is installed and executed on their respective electronic devices 202, 204, and 206. In some examples, the electronic devices 202, 204, and 206 provide viewing data screens with which the users 222, 224, and 226, can interact.

The communication network 210 may include wireless and wired portions. In some embodiments, the communication network 210 is implemented using one or more existing networks, for example, a cellular network, the Internet, a land mobile radio (LMR) network, a Bluetooth™ network, a wireless local area network (e.g., Wi-Fi), a wireless accessory Personal Area Network (PAN), a Machine-to-machine (M2M) network, and a public switched telephone network. The communication network 210 may also include future developed networks. In some embodiments, the communication network 210 includes the Internet, an intranet, an extranet, or an intranet and/or extranet that is in communication with the Internet. In some embodiments, the communication network 210 includes a telecommunication or a data network.

In some embodiments, the communication network 210 connects web sites, devices (e.g., the electronic devices 202, 204, and 206) and back-end systems (e.g., the back-end system 230). In some embodiments, the communication network 210 can be accessed over a wired or a wireless communications link. For example, mobile computing devices (e.g., the smartphone device 202 and the tablet device 206), can use a cellular network to access the communication network 210.

In some embodiments, the back-end system 230 includes at least one server 232 and at least one data store 234. In some embodiments, the server 232 is sustainably similar to device 210 depicted in FIG. 2. In some embodiments, the server 232 is a server-class hardware type device. In some embodiments, the back-end system 230 includes computer systems using clustered computers and components to function as a single pool of seamless resources when accessed through the communications network 210. For example, such embodiments may be used in data center, cloud computing, storage area network (SAN), and network attached storage (NAS) applications. In some embodiments, the back-end system 230 is deployed using a virtual machine(s).

In some embodiments, the data store 234 is a repository for persistently storing and managing collections of data. Example data store that may be employed within the described system include data repositories, such as a database as well as simpler store types, such as files, emails, and so forth. In some embodiments, the data store 234 includes a database. In some embodiments, a database is a series of bytes or an organized collection of data that is managed by a database management system (DBMS).

In some embodiments, the back-end system 230 hosts one or more computer-implemented services provided by the described system with which users 222, 224, and 226 can interact using the respective electronic devices 202, 204, and 206. For example, in some embodiments, the back-end system 230 is configured to provide various components and modules of the example system 300 as described with reference to FIG. 3.

FIG. 3 depicts an example of an infrastructure resilience assessment system 300. As depicted, the infrastructure resilience assessment system 300 includes a user interface 125, system configurations 310, an infrastructure resilience assessment module 320, and a maintenance module 330. In one example, the user interface 125 is executed by one of the electronic devices 202, 204, and 206 shown in FIG. 2 and is employed by the respective user 222, 224, or 226 to interact with the infrastructure resilience assessment module 320, which is hosted by the back-end system 230.

The system configurations 310 include configuration files. Generally, configuration files are files used to configure various parameters and initial settings for a computer program (e.g., the infrastructure resilience assessment module 320). In some embodiments, these configuration files are stored directly on non-volatile memory (e.g., storage unit 114). In some embodiments, these configuration files are stored to the data store 234. Configuration files are used for user applications, server processes and operating system settings.

The system configurations 310 includes specific configuration files for aggregation parameters 312, event definitions 314, upgrade definitions 316, and analysis specifications 318. These specific configuration files provide organization for the related data upon initial access to the infrastructure resilience assessment module 320. As depicted in the example provided in FIG., 3, the infrastructure resilience assessment module 320 is a computer program executed by the electronic processor of a computer, such as the server 232.

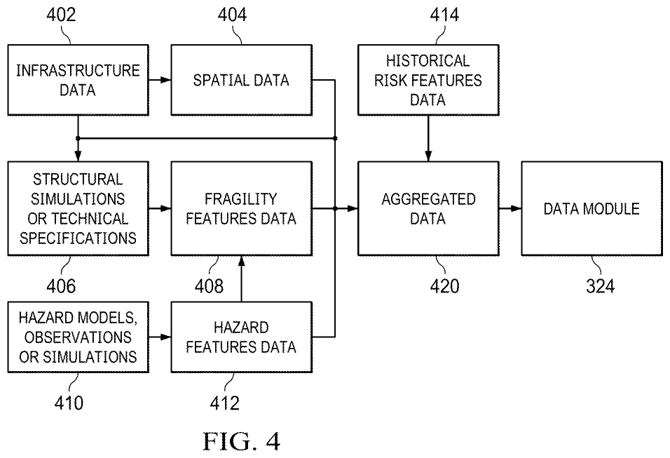

With continued reference to FIG. 3, the infrastructure resilience assessment module 320 includes an analysis module 322, a data module 324, and a modeling module 326. In general, the data module 324 collects, processes, and aggregates data that is employed to train various models. The various models are trained with inputs. FIG. 4 depicts examples of various inputs that are provided to the data module 324. As depicted in FIG. 4, the inputs 400 include infrastructure data 402, spatial data 404, fragility features data 408, hazard features data 412, and historical risk feature data 414. The various inputs 402, 404, 408, 412, and 414 are aggregated to provide aggregated data 420 before being input to the data module 324.

In some embodiments, the data module 324 processes the aggregated data 420 to determine values for each infrastructural unit and hazard event for a range of descriptive variables. In some embodiments, the data module 324 aggregates the data for each infrastructural unit to a configured grouping (e.g., a town, country, circuit, or branch) by calculating various numerical values for each group of infrastructure from the descriptive variables. Table 1 shows an example output from the data module 324.

TABLE 1
Example Identification Data

| Identification | | | | | Infrastructure | | | | | | Environmental Features | | | |
|---|---|---|---|---|---|---|---|---|---|---|---|---|---|---|
| Data | | Hazard Features | | | Features | | | Fragility Features | | | | Leaf | | Risk |
| | Event | Max | Max | | Pole | Pipe | | Fragility | Critical | | Branch | Area | | Feature |
| Unit | Name | Temp | Wind | . . . | Count | Size | . . . | Score | Winds | . . . | Distance | Index | - - - | Damages |
| 00001 | Event | 21 | 16 | . . . | 87 | 20 | . . . | 0.021 | 75 | . . . | 10 | 1.1 | . . . | 3 |
| | A | | | | | | | | | | | | | |
| 00002 | Event | 24 | 20 | . . . | 121 | 37 | . . . | 0.103 | 52 | . . . | 52 | 2.5 | . . . | 2 |
| | A | | | | | | | | | | | | | |
| 00001 | Event | 32 | 32 | . . . | 87 | 20 | . . . | 0.005 | 98 | . . . | 10 | 4.9 | . . . | 5 |
| | B | | | | | | | | | | | | | |
| ↓ | ↓ | ↓ | ↓ | ↓ | ↓ | ↓ | ↓ | ↓ | ↓ | ↓ | ↓ | ↓ | ↓ | ↓ |

In some embodiments, Identification Data, as shown in Table 1, includes labels generated by the data module 324 to identify how each data entry is aggregated. For example, if an embodiment of the described system is employed to analyze the resilience of infrastructure in towns during storms, the data module 325 can aggregate data values by town and by storm and provide labels for each output identifying the town and the storm for each entry in the output data.

The configuration files 310 introduced above provide tools for configuring and organizing the data that is input to or received by the data module 324. As an example, the aggregation parameters 312 configuration file defines how rows generated by the data module 324 are developed. For example, data can be aggregated by various units such as: towns, counties, electrical circuits, and the like. Generally, the event definitions 314 configuration file defines how the data module 324 aggregates information temporally. For example, the ‘Event Name’ (see Table 1 above) may be specified while each event is linked with a specific time range and place. Generally, the upgrade definitions 316 configuration file defines the types of changes a user may evaluate in an infrastructure and how these types of changes influence the data determined by the data module 324. As an example, if a utility wants to install a stronger utility pole in 15% of its territory, the data module 324 could be used to train an AI model and provide an output to a user to understand how the stronger utility poles influence a ‘Fragility Score’. Generally, the analysis specifications 318 configuration file refers to the configurations and embodiments of the described system in which a user is most interested. For example, the analysis specifications 318 configuration file is employed by the analysis module 322 to control the output provided by the data module 324 (see the description below for the analysis module 322).

Returning to FIG. 4, in some embodiments, infrastructure data 402 is derived from survey or asset management data maintained by, for example, municipalities, utility companies, infrastructure managers, or other parties. Other factors such as asset age, material, size, and configurations may also be used. As depicted in FIG. 4, the infrastructure data 402 may also be employed to train technical specification and physical simulation models 406, which are used to determine the fragility data 408 (see below). In some embodiments, real-time data of the functional state of a component in the infrastructural system is also employed. In some embodiments, this real-time data is gathered and communicated by sensor (e.g., a supervisory control and data acquisition (SCADA) system), or otherwise modeled or inferred by real-time operational conditions or performance.

In some embodiments, the fragility data 408 describes the relative sensitivity of the infrastructural system to a hazard. In some embodiments, the fragility data 408 is derived from the age, configuration, and material of the infrastructural system components. In some embodiments, the fragility data 408 includes tabulated values of measures of mechanical toughness such as tensile strength, compressive strength, and the like.

In some embodiments, the fragility data 408 is determined or based on output from technical specification and physical simulation models 406. In some embodiments, the technical specification and physical simulation models 406 include technical specifications of infrastructural system components or physical simulations of configurations of the infrastructural system. In some embodiments, the technical specification and physical simulation models 406 are performed in a laboratory environment. In some embodiments, the technical specification and physical simulation models 406 include a numerical computer model. In some embodiments, the technical specification and physical simulation models 406 are configured to simulate a range of characteristics of the infrastructural system. In some embodiments, the fragility data 408 for the infrastructural system is determined based on a range of characteristics, configurations, and hazard exposures as modeled by the technical specification and physical simulation models 406.

In some embodiments, the hazard features data 412 is derived from simulations or trained models (e.g., weather prediction models, numerical weather prediction models, or global circulation models), forecasts, or observations 410 of the natural hazard that presents the risk to the infrastructural system. For example, the hazard features data 412 may be determined by processing forecast data through one or more weather prediction models 410 that are configured to simulate a hurricane (e.g., wind speed, precipitation, and the like) and trained with radar observations or other weather models. As another example, the hazard features data 412 may be determined by an earthquake model 410 trained using observed or simulated seismographs. In some embodiments, the various models 410 are trained with historical observations to simulate an historical event. These various models 410 can be employed to provide insights about an event and the effects of various contributing factors of the event. In some embodiments, the hazard models 410 are trained to simulate a hypothetical scenario or event such that the determined hazard features data 412 provides information regarding the impact of the scenario or event.

In some embodiments, environmental features are derived from spatial data 404, which describes a range of environmental characteristics that can exacerbate or mitigate the wear or impacts of hazards on the infrastructural system. For example, the spatial data 404 may include information regarding trees, other vegetation, soils, season, drought, land use, elevation, or other orographic features. In some embodiments, the spatial data 404 is collected by satellites (e.g., satellite imagery), drones (e.g., aerial imagery), or other large-scale survey devices or tools. In some embodiments, the spatial data 404 includes information related to environmental factors or features, such as vegetation, elevation, soils, and the like.

In some embodiments, historical risk features data 414 is determined from the technical specification and physical simulation models 406 or the simulations or trained models, forecasts, or observations 410. In some embodiments, the historical risk features data 414 includes the probable number of damaged assets, the probability of having damages, the probable duration of repair work for each event, the expected cost of damage, or reliability metrics or indices for the infrastructure such as the system average interruption frequency index (SAIFI) or the system average interruption duration index (SAIDI).

Returning to FIG. 3, in some embodiments, the modeling module 326 includes a machine learning based system that interacts with the data module 324 to train a machine learning algorithm to form an infrastructural system model 328. Generally, the modeling module 326 trains the infrastructural system model 328 with historical data provided by the data module 324. In some embodiments, the size and nature of the historical data used to train the infrastructural system model 328 is specific to each application and determined according to the system configurations 310. Example machine learning algorithms that can be employed include, but are not limited to, random forest, gradient boosted trees, multi-layered perceptrons, and any number of convolutional or deep neural network algorithms (see below for additional information).

In some embodiments, the modeling module 326 processes scenario specific data through the trained infrastructural system model 328 to determine an output (e.g., one or more predictions). In some embodiments, the scenario specific data is determined based on the system configurations 310. In some embodiments, the scenario specific data, as provided by the data module 324, is consistent with training data employed to train the infrastructural system model 328. For example, the modeling module 326 may process scenario specific data that includes information regarding historical events, which were not employed to train the infrastructural system model 328. Example scenario specific data includes forecasted hazardous events, synthetic “what-if” scenarios generated by a user via the analysis module 322, or hazardous events from other regions or infrastructural systems of the same type as employed to train the infrastructural system model 328.

In some embodiments, scenario specific data is consistent with training data based on similar variables and the overall information available. For example, the scenario specific data provided to a model trained with precipitation data is more consistent with the precipitation data used in training, if the same type of precipitation estimates are included. Moreover, in such an example, the scenario specific data may also have similar numeric characteristics when compared to the precipitation data (the data used to train the model). As another example, the way in which data is measured (e.g., precipitation via a rain gauge, a radar scan, or a satellite) may introduce differences in the measurements. As such, scenario specific data is more consistent with training data when the same mechanism or tool is employed to measure each data set (e.g., employing scenario specific data based on data provided by a satellite when the training data is also based on data provided by a satellite). In some embodiments, scenario specific data includes predictions or simulation data (e.g., simulating future climate change) where the scenario data may not be consistent.

In some embodiments, the modeling module 326 determines the risk features data 414 (see FIG. 4) that is associated with the configured conditions and does not receive the risk features data 414 from the data module 324.

In some embodiments, the analysis module 322 controls the data module 324 and the modeling module 326 and coordinates the configuration and interaction between them. In some embodiments, the analysis module 322 receives and interprets input from the user interface 125 and provides system outputs to the user interface 125. For example, the analysis module 322 may be configured, based on the system configurations 310, to provide output to the user interface 125 with resilience estimates for historical analysis, short-term forecasts, long-term forecasts, hypothetical scenarios, and the like.

For historical analysis, the data module 324 may provide historical data and hazardous data events to the modeling module 326 for processing through the infrastructural system model 328 to determine estimates of the historical reliability of the infrastructural system. For forecasts, the data module 324 may provide forecasts or simulations to the modeling module 326 for processing through the infrastructural system model 328 to determine reliability forecasts of the infrastructural system.

For hypothetical scenarios, the data module 324 may provide synthetic data to the modeling module 326 for processing through the infrastructural system model 328. In some embodiments, the synthetic data is generated by applying modifications to simulated, forecasted, or historical data based on a set of user-configured scenarios or infrastructure plans. With this approach, a user can generate reliability estimates for various hypothetical scenarios and simulate the effect of changes to the infrastructural systems. For example, in one configuration, a user could estimate a “what-if” scenario for upgrades to the materials of infrastructural system components during a famous or particularly disruptive event (e.g., Hurricane Katrina). The analysis module 322 may then modify the historical data from the selected event to reflect the specified upgrade to the infrastructural system component materials. The analysis module 322 may then be employed to evaluate the reliability of an upgraded system during the selected event, which may then be compared to the estimated reliability for the event using actual data or synthetic data for the event.

In some embodiments, the analysis module 322 generates reliability estimates for one or more hazardous events with the data module 324 and the modeling module 326. In some embodiments, the analysis module 322 provides the reliability estimates for a probability of failure, which include a vulnerability metric, for components modeled by the infrastructural system model 328 to a maintenance module 330. In some embodiments, the maintenance module 330 analyzes the received data to determine a recommended maintenance task for at least one of the modeled components. In some embodiments, the maintenance module 330 provides the recommended maintenance task and the reliability estimates to the user interface 125. In some embodiments, the user interface 125 can prompt a user to schedule the recommended maintenance. In some embodiments, the maintenance module 330 can provide a schedule or timeline as to when maintenance, service, replacement, or upgrade should occur to prevent failure of a component in the infrastructural system. The output provided to the user on the user interface 125 may include a calendar view, charts, tables, or other suitable representations of the data and information. Maintenance and refurbishment information is used to determine the routine cycle and long-term replacement expenses associated with the ongoing care and upkeep of the components in the infrastructural system associated with the modeled system. The recommended maintenance information may include data on the age, preventive maintenance schedules, and past performance data or history of equipment and structures in the infrastructural system. The maintenance module 330 may interface with other modules, such as a component library for identifying components (not shown) and a procurement module (not shown) for presenting options on procurement of components designated for maintenance.

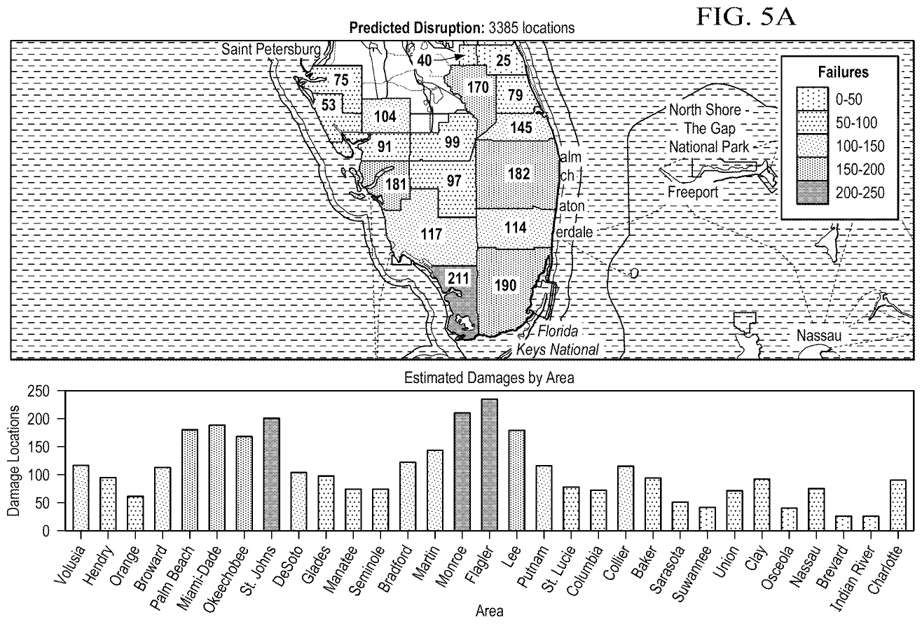

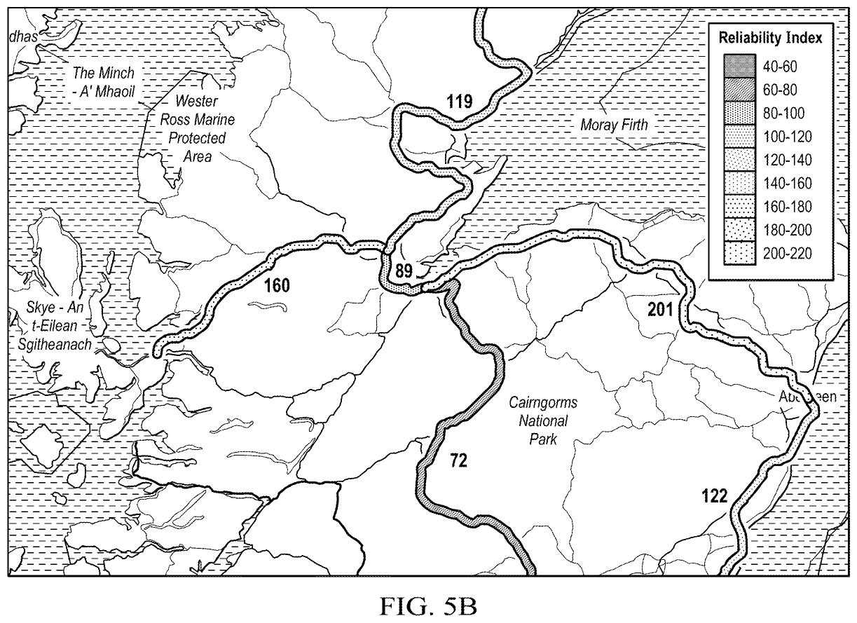

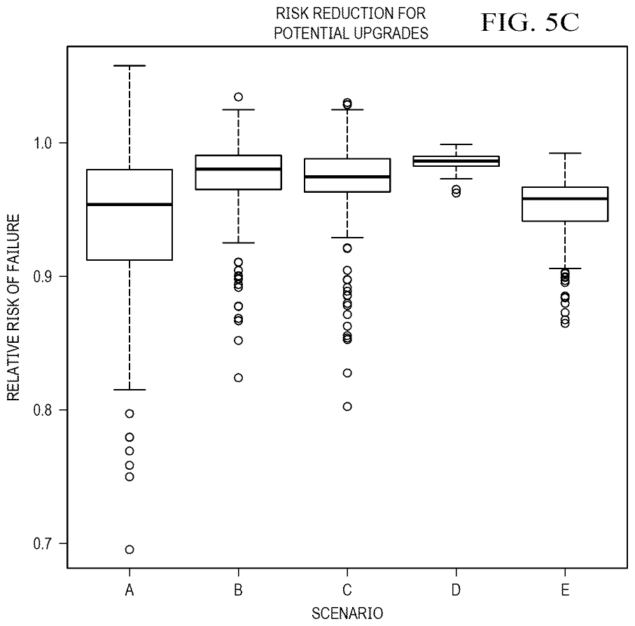

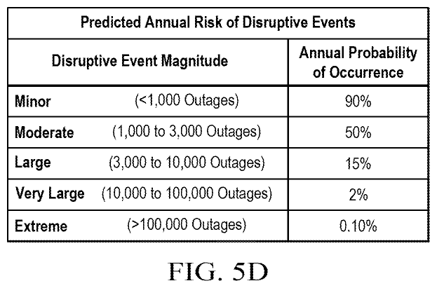

In some embodiments, single event estimates are provided to the user interface 125 via the analysis module 322 for reviewing performance of previous events or preparing for forecasted events (see FIG. 5A). In some embodiments, an analysis of a number of events is provided to the user interface 125 for long-term evaluation of system performance or strategic planning purposes (see FIG. 5B). By using more than one event, hypothetical changes to the infrastructural system can be evaluated over long periods of time, and the relative risk to the infrastructure can be evaluated (see FIG. 5C). In some embodiments, the historical analysis can be employed to compare the reliability of an upgraded or otherwise altered infrastructural system historical performances of the existing infrastructural system. In some embodiments, the historical analysis can be employed to estimate the long-term effects of upgrades based on long-term simulations using climate or statistical simulations of hazards. Moreover, aggregated reliability of the infrastructural system can be measured and analyzed when a large number of hazardous events are analyzed.

In some embodiments, users may employ the analysis module 322, via the user interface 125, to calculate the frequency and return periods of hazards based on their estimated impacts (see FIG. 5D). For example, infrastructural managers can anticipate the long-term frequency of particularly disruptive events and estimate how changes in climatic patterns or upgrades to their infrastructure would affect the frequency of events of various magnitudes based on the information provided by the analysis module 322.

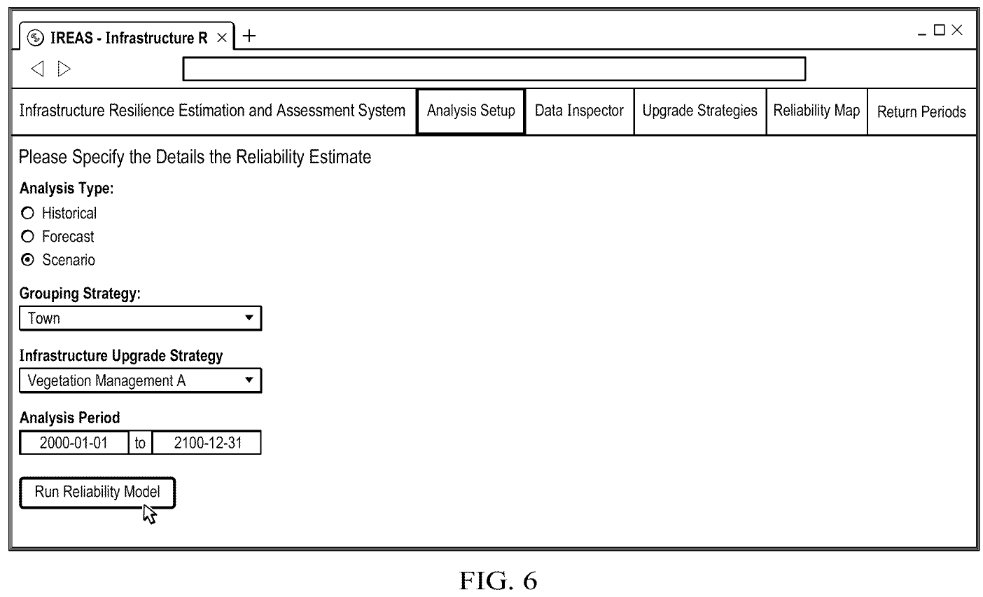

FIG. 6 depicts an example page or screen 600 that can be provided to a user via the user interface 125. In one embodiment, the example page is a part of an Infrastructure Resilience Estimation and Assessment System interface. This interface may allow users to control the behavior of the analysis module 322 by specifying, for example, the type of analysis of interest, how data is aggregated by the data module 324, the parts of the infrastructural system that are included in the analysis, the hazardous events or time periods of events that are used in the model training and analysis, the reliability metrics that are of interest, or the types and specifications of proposed upgrades to the infrastructural system. Based on the provided user input, in some embodiments, the analysis module 322 provides instructions to the data module 324 and the modeling module 326 to generate output and to create the desired analytical products. The form of these results may vary as needed. For example, for short-term forecasts, the outputs of the analysis module 322 can be formatted and communicated as alerts. These alerts may be provided to users via, for example, short message service (SMS) or multimedia messaging service (MMS) text messages, electronic mail, or automated phone calls. For strategic reliability analysis, plots, graphs, maps, and tables describing aggregated reliability can be generated and displayed via the user interface 125. Such outputs can be packaged into an automated report, provided as a file (e.g., via email or SMS), or published on an accessible medium (e.g., a website).

In some embodiments, users can, via the user interface 125, interactively investigate and customize generated outputs (e.g., with options for sub-setting the results and generating specific plots based on user preferences). Thus, users may employ the described infrastructure resilience assessment system to generate informative estimates about the reliability of the infrastructural system for a range of historical, forecasted, or hypothetical situations.

FIG. 7 depicts a flowchart of an example process 700. The example process 700 can be implemented by the components of the infrastructure resilience assessment system 300 described above with respect to FIG. 3. The example process 700 generally shows in more detail how scenario specific data is processed through the infrastructural system model 328 to assess the resilience of an infrastructural system. Relevant output is provided to a user via the user interface 125.

For clarity of presentation, the description that follows generally describes the example process 700 in the context of FIGS. 1-6. However, it will be understood that the process 700 may be performed, for example, by any other suitable system, environment, software, and hardware, or a combination of systems, environments, software, and hardware as appropriate. In some embodiments, various operations of the process 700 can be run in parallel, in combination, in loops, or in any order.

At 702, scenario specific data regarding an infrastructural system is received from the user interface 125. In some embodiments, the scenario specific data includes forecasted hazardous events, synthetic scenarios, or hazardous events from the past, other regions, or infrastructural systems of the same type as the infrastructural system being analyzed. In some embodiments, the infrastructural system is defined or categorized according to a technical function, a geographical location, or political borders. In some embodiments, the infrastructural system comprises a collection of infrastructural components. In some embodiments, the infrastructural components include electrical grid components (e.g., electrical conductors, support structures, transformers), electrical generation components (solar panels, wind turbines, generators), water system components (e.g., pipes, fittings, pumps), telecommunication components (e.g., network devices such as routers, switches, modems, and multiplexers), transportation infrastructure (e.g., roads, bridges, signals), and the like. From 702, the process 700 proceeds to 704.

At 704, the scenario specific data is processed by the infrastructure resilience assessment module 320 to determine a vulnerability metric for a probability of failure for a component of the infrastructural system. In some embodiments, the probability of failure for the component of the infrastructural system is determined by processing the scenario specific data through the infrastructural system model 328. In some embodiments, the environmental conditions are determined according to the infrastructural system model and the scenario specific data. In some embodiments, the infrastructural system model 328 is trained with historical data that includes infrastructure data, spatial data, fragility features data, hazard features data, or historical risk feature data, regarding the infrastructural system. In some embodiments, the scenario specific data is consistent with the historical data. In some embodiments, the fragility features data is determined based on a technical specification, a physical simulation model, or a plurality of fragility curves related to the infrastructural system. In some embodiments, the fragility curves are generated based on observations, physical tests, or a computer simulation. In some embodiments, the technical specification and physical simulation model is trained with the infrastructure data. In some embodiments, the hazard features data is determined based on a simulation model trained with forecast data or observations of natural hazards. In some embodiments, the simulation model comprises a weather prediction model, a numerical weather prediction model, or a global circulation model. In some embodiments, the infrastructural system model 328 is retrained with the determined probability of failure for the component of the infrastructural system. In some embodiments, the scenario specific data is processed to determine a plurality of analytical results related to the infrastructural system. In some embodiments, the analytical results relate to a subset of components of the infrastructural system. In some embodiments, the analytical results include a physical response of the components and materials of the infrastructural system that are exposed to hazards, a response in the operational capacity of the components of an infrastructural system that are exposed to hazards, an overall reliability of the infrastructural system over periods of time. The analytical results can include a scenario-based analysis evaluating the effects of upgrades to the infrastructural system or other hypothetical scenarios. The analytical results can include a physical response of components and materials exposed to hazards or component fragility for component designs and configurations developed from manufacturer technical specifications, laboratory tests, or computerized physical simulations. From 704, the process 700 proceeds to 706.

At 706, an in-situ failure risk of the infrastructural system incorporating a complexity of environmental conditions is determined based on the vulnerability metric. In some embodiments, the in-situ failure risk incorporates a complexity of environmental conditions.

In some embodiments, the infrastructural system model 328 incorporates the complexity of environmental conditions by calculating failure risk scores based on various local or contemporaneous environmental factors. The contemporaneous environmental factors include soil properties, type and prevalence of local vegetation, drought conditions, or wind speeds, and the like. In some embodiments, the in-situ failure risk of the infrastructural system includes an aggregate risk of failure for a particular hazardous event. From 706, the process 700 proceeds to 708.

At 708, a recommend maintenance task for the component of the infrastructural system is determined based on the vulnerability metric. From 708, the process 700 proceeds to 710.

At 710, the in-situ failure risk of the infrastructural system and the recommend maintenance task for the component of the infrastructural system is provided to the user interface 125. The in-situ failure risk may be a numerical value and/or may be represented in a pictorial format or graphical format on the user interface 125. In some embodiments, the user interface is configured to prompt the user to schedule the recommend maintenance task. From 710, the process 700 ends.

Non-transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In still further embodiments, a computer readable storage medium is optionally removable from a computer. In some embodiments, a computer readable storage medium includes, by way of non-limiting examples, compact disc read-only memories (CD-ROMs), digital versatile discs (DVDs), flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

Computer Program

In some embodiments, the platforms, systems, media, and methods disclosed herein include at least one computer program, or use of the same. A computer program includes a sequence of instructions, executable in the CPUs of the computer, written to perform a specified task. Computer readable instructions may be implemented as program modules, such as functions, objects, application programming interface (API), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Machine Learning

In some embodiments, machine learning algorithms are employed to build a model to assess the resilience of an infrastructural system. Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets. For example, previously received contextual data may be employed to train various algorithms. Moreover, as described above, these algorithms can be continuously trained/retrained using real-time user data as it is received. In some embodiments, the machine learning algorithm employs regression modeling where relationships between variables are determined and weighted. In some embodiments, the machine learning algorithm employs regression modeling, wherein relationships between predictor variables and dependent variables are determined and weighted.

Mobile Application

In some embodiments, a computer program includes a mobile application provided to a mobile device. In some embodiments, the mobile application is provided to a mobile device at the time it is manufactured. In other embodiments, the mobile application is provided to a mobile computer via the computer network described herein. A mobile application is created by techniques known to those of skill in the art using hardware, languages, and development environments known to the art. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Standalone Application

In some embodiments, a computer program includes a standalone application, which is a program that is run as an independent computer process, not an add-on to an existing process, (e.g., not a plug-in). Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

Software Modules

In some embodiments, the systems and methods disclosed herein include software, server, or database modules. Software modules are created using machines, software, and languages. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Data Stores

In some embodiments, the platforms, systems, media, and methods disclosed herein include one or more data stores. Data stores include repositories for persistently storing and managing collections of data. Types of data stores repositories include, for example, databases and simpler store types, or use of the same. Simpler store types include files, emails, and so forth. In some embodiments, a database is a series of bytes that is managed by a DBMS. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In some embodiments, a database is cloud computing based.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. The term “approximately” as used herein refers to any values, including both integers and fractional components that are within a variation of up to ±10% of the value modified by the term “about.” In certain aspects, the term “approximately” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “approximately” can mean within 3 or more than 3 standard deviations, per the practice in the art.

It is understood that the foregoing detailed description and accompanying examples are merely illustrative and are not to be taken as limitations upon the scope of the invention.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example embodiments does not define or constrain this disclosure. Other changes, substitutions, and alterations are also possible without departing from the spirit and scope of this disclosure.

What is claimed is:

1. A computer program product stored on non-transitory machine-readable media and comprising machine executable instructions for implementing a method for assessing the resilience of an infrastructural system, the method comprising:
receiving, from an interface, scenario specific data regarding conditions for the infrastructural system;
processing the scenario specific data to determine a vulnerability metric for a probability of failure for a component of the infrastructural system;
determining, based on the vulnerability metric, an in-situ failure risk of the infrastructural system incorporating a complexity of environmental conditions;
determining, based on the vulnerability metric, a recommended maintenance task for the component of the infrastructural system; and
providing the in-situ failure risk of the infrastructural system and the recommended maintenance task for the component to the interface.

2. The computer program product of claim 1, wherein the probability of failure for the component of the infrastructural system is determined by processing the scenario specific data through an infrastructural system model, and wherein the environmental conditions are determined according to the infrastructural system model and the scenario specific data.

3. The computer program product of claim 2, wherein the infrastructural system model is trained with historical data that includes infrastructure data, spatial data, fragility features data, hazard features data, or historical risk feature data, regarding the infrastructural system.

4. The computer program product of claim 3, wherein the scenario specific data is consistent with the historical data.

5. The computer program product of claim 3, wherein the fragility features data is determined based on a technical specification, a physical simulation model, or a plurality of fragility curves related to the infrastructural system, and wherein the fragility curves are generated based on observations, physical tests, or a computer simulation.

6. The computer program product of claim 5, wherein the technical specification and the physical simulation model are trained with the infrastructure data.

7. The computer program product of claim 3, wherein the hazard features data is determined based on a simulation model trained with forecast data or observations of natural hazards.

8. The computer program product of claim 7, wherein the simulation model comprises a weather prediction model, a numerical weather prediction model, or a global circulation model.

9. The computer program product of claim 2, wherein the infrastructural system model is retrained with the determined probability of failure for the component of the infrastructural system.

10. The computer program product of claim 2, wherein the infrastructural system model incorporates the complexity of environmental conditions by calculating failure risk scores based on various local or contemporaneous environmental factors, and wherein the contemporaneous environmental factors include soil properties, type and prevalence of local vegetation, drought conditions, or wind speeds.

11. The computer program product of claim 1, wherein the scenario specific data includes forecasted hazardous events, synthetic scenarios, or hazardous events from the past, other regions, or infrastructural systems of the same type as the infrastructural system.

12. The computer program product of claim 1, wherein the infrastructural system is defined according to a technical function, a geographical location, or political borders.

13. The computer program product of claim 1, wherein the in-situ failure risk of the infrastructural system includes an aggregate risk of failure for a particular hazardous event.

14. The computer program product of claim 1, wherein the method further comprises:
processing the scenario specific data to determine a plurality of analytical results related to the infrastructural system.

15. The computer program product of claim 14, wherein the analytical results relate to a subset of components of the infrastructural system.

16. The computer program product of claim 14, wherein the analytical results include a physical response of components and materials of the infrastructural system that are exposed to hazards, a response in the operational capacity of the components of an infrastructural system that are exposed to hazards, an overall reliability of the infrastructural system over periods of time; a scenario-based analysis evaluating the effects of upgrades to the infrastructural system or other hypothetical scenarios; a physical response of components and materials exposed to hazards; or component fragility for component designs and configurations developed from manufacturer technical specifications, laboratory tests, or computerized physical simulations.

17. The computer program product of claim 1, wherein the infrastructural system comprises a collection of infrastructural components; and wherein the infrastructural components include electrical grid components, electrical generation components, natural gas distribution system components, water system components, telecommunication components, or transportation infrastructure.

18. A system for assessing resilience of an infrastructural system, the system comprising:
a user device having a user interface, the user device including an electronic processor configured to:
receive, from the user interface, scenario specific data regarding conditions of the infrastructural system;
process the scenario specific data to determine a vulnerability metric for a probability of failure for a component of the infrastructural system;
determine, based on the vulnerability metric, an in-situ failure risk of the infrastructural system incorporating a complexity of environmental conditions;
determine, based on the vulnerability metric, a recommended maintenance task for the component of the infrastructural system; and
provide the in-situ failure risk of the infrastructural system and the recommended maintenance task for the component to the user interface.

19. The method of claim 18, wherein the electronic processor is configured to, before processing the scenario specific data, train an infrastructural system model with historical data that includes infrastructure data, spatial data, fragility features data, hazard features data, or historical risk feature data, regarding the infrastructural system.

20. A computer implemented method for assessing the resilience of an infrastructural system, the method comprising:
receiving, from an interface, scenario specific data regarding conditions for the infrastructural system;
processing the scenario specific data to determine a vulnerability metric for a probability of failure for a component of the infrastructural system;
determining, based on the vulnerability metric, an in-situ failure risk of the infrastructural system incorporating a complexity of environmental conditions;
determining, based on the vulnerability metric, a recommended maintenance task for the component of the infrastructural system; and
providing the in-situ failure risk of the infrastructural system and the recommended maintenance task for the component to the interface.
